(19) United States
(12) Patent Application Publication
(10) Pub. No.: US 2008/0232195 A1
(43) Pub. Date: Sep. 25, 2008

(54) Apparatus and Method for Processing Geophysical Information

(75) Inventors: Robert I. Bloor, Houston, TX (US); David A. Cunningham, Superior, CO (US)

Correspondence Address: EDMONDS, P.C., 16815 ROYAL CREST DRIVE, SUITE 130, HOUSTON, TX, 77058, US

(73) Assignee: Input/Output, Inc., Houston, TX (US)

(21) Appl. No.: 12/050,731

(22) Filed: Mar. 18, 2008

Related U.S. Application Data
(60) Provisional application No. 60/895,945, filed on Mar. 20, 2007.

(51) Int. Cl. G01V 1/28

(52) U.S. Cl. 367/38; 702/14

(57) ABSTRACT

A seismic information processing method for determining a property related to an earth subsurface structure includes performing a first processing operation on geophysical information using a computer operating according to a first processing parameter set and generating a first result from the first processing operation. The method may include performing a second processing operation on the first result using the computer and generating a second result from the second operation. At least one measurement point of the second result is evaluated using the computer. The first processing parameter set may be varied at least once to a second processing parameter for processing the geophysical information. The first operation, the second operation and the evaluation are repeated using the second processing parameter set. At least one of the first result, the second result and the evaluation is used for generating the property relating to the earth subsurface structure.

### CROSS-REFERENCE TO RELATED APPLICATIONS

The present application is a non-provisional application of U.S. Provisional Application Ser. No. 60/895,945 for “Apparatus and Method for Processing Geophysical Information” filed on Mar. 20, 2007 the entire application being incorporated herein by reference.

### BACKGROUND

1. Technical Field

The present disclosure generally relates to seismic prospecting and in particular to methods and apparatus for processing geophysical information.

2. Background Information

In the oil and gas exploration industry, geophysical tools and techniques are commonly employed in order to identify a subterranean structure having potential hydrocarbon deposits. These techniques and tools are often commonly referred to as seismic exploration. Seismic exploration is used to generate an image of subsurface structures by recording energy in the form of vibrations after the energy has been imparted into the earth and has reflected or refracted from geologic formations.

In seismic exploration, so called seismic waves travel through the ground and reflect off rocks in the subsurface. Boundaries between different rocks often reflect seismic waves, and information relating to these waves is collected and processed to generate a representation or “pictures” of the subsurface. Any number of exploration systems may be used to gather the desired information for processing. Dynamite explosions, vibrator trucks, air guns or the like may be used to create the seismic waves, and sensors such as velocity geophones, accelerometers and/or hydrophones may be laid out in lines, or towed in the case of hydrophones, for measuring how long it takes the waves to leave the seismic source, reflect off a rock boundary, and return to the sensors used.

A two-dimensional image, which is called a seismic line, is essentially a cross-sectional view of the earth oriented parallel to the line of geophones. The information may also be collected as an intersecting grid of seismic lines referred to as a 3-D seismic volume.

When seismic waves generated by a source reach a bedding plane separating rocks of different acoustic density, then a portion of the waves reflects back to the surface, causing the ground surface to rise or fall depending on whether the expansion or compression phase of the wave is being recorded. The remaining portion of the waves is refracted and diffracted.

Seismic prospecting today generally results in an extremely vast amount of information to be processed in order to obtain a subsurface image. Often it is difficult to select sample data and then process and check the data in a timely fashion.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

Disclosed is a method for determining a property related to an earth subsurface structure includes performing a first processing operation on geophysical information using a computer operating according to a first processing parameter set and generating a first result from the first processing operation. A second processing operation is performed on the first result using the computer and a second result is generated from the second operation. At least one measurement point of the second result is evaluated using the computer. The first processing parameter set is varied at least once to a second processing parameter set for processing the geophysical information. The first operation, the second operation and the evaluation are repeated using the second processing parameter set, wherein at least one of the first result, the second result and the evaluation is used for generating the property relating to the earth subsurface structure.

In another aspect, a computer-readable medium having computer executable instructions stored thereon, that when executed using a computer, perform a method that includes performing a first processing operation on geophysical information using a computer operating according to a first processing parameter set, generating a first result from the first processing operation, performing a second processing operation on the first result using the computer, generating a second result from the second operation, evaluating at least one measurement point of the second result using the computer, varying the first processing parameter set at least once to a second processing parameter for processing the geophysical information, and repeating the first operation, the second operation and the evaluation using the second processing parameter set, wherein at least one of the first result, the second result and the evaluation is used for generating the property relating to the earth subsurface structure.

### BRIEF DESCRIPTION OF THE DRAWINGS

For a detailed understanding of the present disclosure, reference should be made to the following detailed description of the several non-limiting embodiments, taken in conjunction with the accompanying drawings, in which like elements have been given like numerals and wherein:

FIG. 1 is a non-limiting example of a seismic spread for generating geophysical information used for imaging earth subsurface structures;

FIG. 2 illustrates a non-limiting example of a geophysical information processing method using quality measurements;

FIG. 3 illustrates a non-limiting example of a method for determining a property related to an earth subsurface structure using a quality measurement and feedback;

FIG. 4 illustrates another non-limiting example of a method for determining a property related to an earth subsurface structure using a quality measurement evaluation and varying a processing parameter set;

FIG. 5 is a non- limiting example of a method using quality measurement points and ranking for several operations; and

FIG. 6 illustrates a non-limiting example of a system used for carrying out several disclosed methods.

### DESCRIPTION OF EXEMPLARY EMBODIMENTS

Portions of the present disclosure, detailed description and claims may be presented in terms of logic, software or software implemented aspects typically encoded on a variety of media including, but not limited to, computer-readable media, machine-readable media, program storage media or computer program product. Such media may be handled, read, sensed and/or interpreted by a computing device having a processor. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

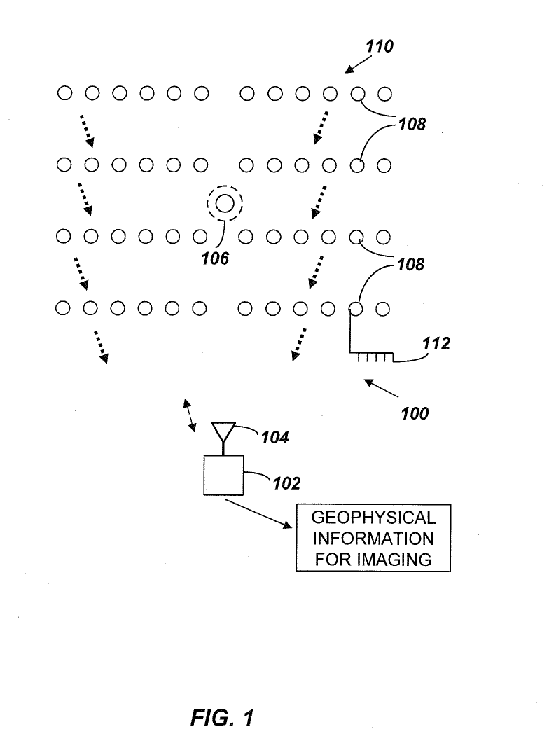

FIG. 1 is a non-limiting example of a seismic spread for generating geophysical information used for imaging earth subsurface structures, which information may be used in the methods described herein. Imaging, as used herein includes any representation of a subsurface structure including, but not limited to, graphical representations, mathematical or numerical representation, strip charts or any other process output representative of the subsurface structure. Shown is a system 100 that includes a central controller/recorder 102 in communication with a seismic acquisition array 110, known as a spread. The array includes spaced apart sensor stations 108, and each sensor station may include a number of sensors 112. A seismic source 106 may be used to impart acoustic energy into the earth, and the energy is received at the sensors 112 after reflection and refraction at boundaries such as those found in earth subsurface structures.

In several non-limiting examples, the system 100 may be deployed on land or at a seabed location. The array 110 may also be implemented as an array of seismic streamers using hydrophones as sensors and using an air gun or dynamite source 108.

In some aspects, the array 110 may communicate with the central controller/recorder 102 using wireless technology as shown using an antenna 104 at the central controller/recorder to receive geophysical information. In another embodiment, the array may utilize not-shown electrical conductor cables for communicating geophysical information among the sensor stations 108 as well as to and from the recorder station 102.

Continuing with the example of FIG. 1, the sensors 112 may include several sensors for measuring geophysical information. The sensors 112 may include 3-component sensors for obtaining 3-dimensional energy known as 3D seismic. The sensors 112 may include accelerometers, velocity geophones, microphones, hydrophones pressure sensors, temperature sensors, magnetometers, global position systems, timing devices or any combination of sensors useful in obtaining geophysical information.

Geophysical information as used herein means information relating to the location, shape, extent, depth, content, type, properties of and/or number of geologic bodies. Geophysical information includes, but is not necessarily limited to marine and land seismic information. Seismic information includes, but is not limited to, one or more or any combination of the following, analog signals, digital signals, recorded data, data structures, database information, parameters relating to surface geology, source type, source location, receiver location, receiver type, time of source activation, source duration, source frequency, energy amplitude, energy phase, energy frequency, wave acceleration, wave velocity and/or wave direction.

Seismic information may be gathered using sensors monitoring seismic activities using, for example, a system as described above and shown in FIG. 1. The seismic activities may be the result or passive and/or active energy sources. Passive seismic energy sources are naturally occurring, and typically uncontrolled, as in structural movements, machinery activity, fluid flow or other environmental energy. Active seismic energy sources may include, but are not limited to, vibrator devices, dynamite, air guns, drop weight and other energy sources, which may be considered as controlled energy sources. The sensors used may include geophones, hydrophones, accelerometers, temperature sensors, pressure sensors, single component sensors and/or multi-component sensors.

In one non-limiting example, gathered seismic information includes any one or combination of P-wave information, S-wave information, pressure information, temperature, timing information, shot information, location information and orientation information. Those skilled in the art will also appreciate that the present disclosure includes processing so-called full wave seismic information.

The disclosed methods may be used for any number of geophysical processing operations. A geophysical information processing session is a combination of process operations. Process operations may be combined to operate as a single operation or may comprise several distinct operations. Some distinct operations include, but are not limited to, noise attenuation operations, wavelet handling operations, imaging operations, and velocity operations. Some distinct operations may include sub-operations. For example, regularization may be a sub-process of an imaging operation. Other operations are also within the scope of the invention. In one non-limiting example, the methods may be used in the context of refraction statics. The term “operation” as used herein includes any manipulation of information and includes applications with several distinct operations and/or several sub-operations within a distinct operation, and/or to a series of combined distinct operations.

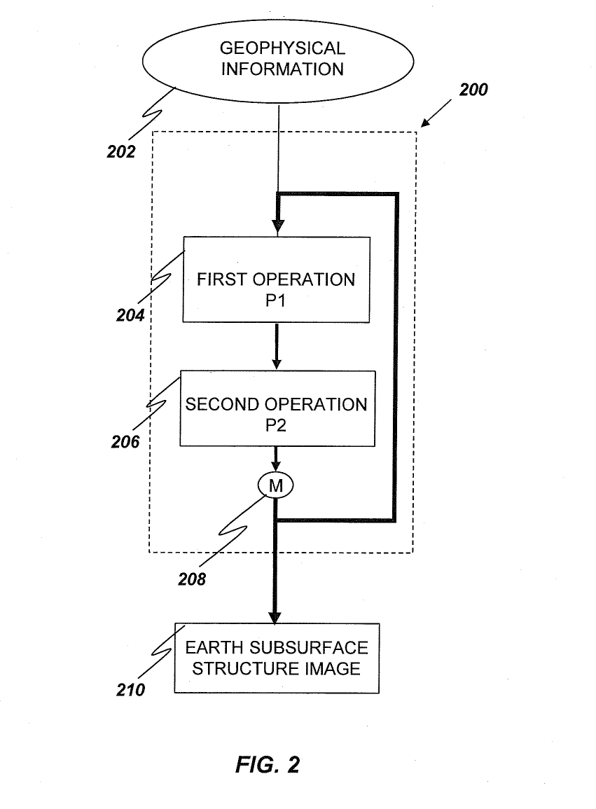

FIG. 2 illustrates a non-limiting example of a geophysical information processing method using quality measurements. Geophysical information gathered using a system 100 as described above and shown in FIG. 1 is entered into a computer system, which will be described later. The method carried out using the computer system includes performing a first operation on the entered geophysical information and then performing a second operation on the output of the first operation. In one non-limiting example, a quality measurement point 208 in the flow is placed at the output of the second operation and a result is fed back into the first output. The output of the second operation may be used for other sub-operations or may be used for determining the subsurface structure property directly. In the non-limiting example shown, the output of the second operation 206 is used for generating an earth subsurface structure image 210.

In one non-limiting example, the first operation and the second operation are selected from geophysical processing operations that include, but are not limited to, noise attenuation operations, wavelet handling operations, imaging operations, velocity operations, and/or refraction statics. In another non-limiting example, the first operation and the second operation are selected sub-operations within one or more of attenuation operations, wavelet handling operations, imaging operations, velocity operations, and/or refraction statics.

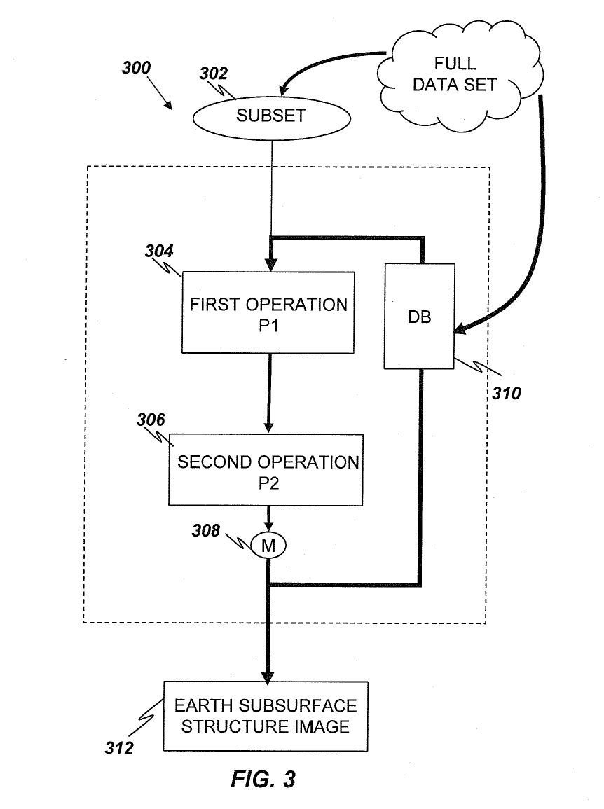

FIG. 3 illustrates a non-limiting example of a method 300 for determining a property related to an earth subsurface structure using a quality measurement and feedback. In one example either a subset of geophysical information or all picks may be used for processing and measuring. In one non-limiting example, an automated process uses a quality measurement point for model statics to determine whether the model “fits” the original selected data. In one aspect, the model is used to predict picked information. A pick as used herein is defined to be a triplet of geophysical information values (x₀, t₀, Δt/Δx) where x₀ is an inline coordinate at which a measurement is made, to is the normal-incidence travel time (two way) measured at x, and Δt/Δx is the horizontal gradient of normal-incidence travel time measured at (x, t₀).

Pick information may be entered 302 into a computer system performing several operations for determining a property of an earth subsurface structure. A first operation is performed 304 on the entered information. An output of the first operation is fed to a second operation 306 and a quality measurement point performed 308 on an output of the second operation. The second operation so measured is fed to a model 310, which may include a database of the full data set of geophysical information. For example, the database may include all picks from a particular seismic survey. The model then may evaluate the original information entered and predict the picks best suited for processing from the full pick data set. In this manner all picks may be measured efficiently based on an initial pick set.

An output of the second process may then be used for further operations 312. In one example, the output of the second process is used for determining the subsurface property, which may include an image of the earth subsurface structure. As used herein, a subsurface property includes any information relating to the location, size, contact points, borders, shape, type, and content of a subsurface formation.

Although the example of FIG. 3 is discussed in terms of pick information, the method may be applied to any geophysical information and process operations. In one non-limiting example, the first operation and the second operation are selected from geophysical processing operations that include, but are not limited to, noise attenuation operations, wavelet handling operations, imaging operations, velocity operations, and/or refraction statics. In another non-limiting example, the first operation and the second operation are selected sub-operations within one or more of attenuation operations, wavelet handling operations, imaging operations, velocity operations, and/or refraction statics.

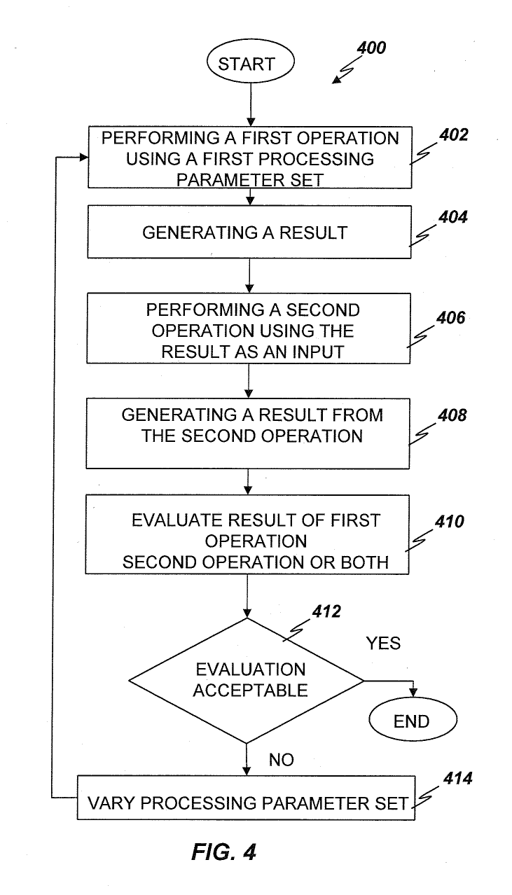

FIG. 4 illustrates a method 400 for determining a property related to an earth subsurface structure using geophysical information, which may be originally gathered using a system 100 as described above and shown in FIG. 1. The flow begins by performing a first operation 402 using a first processing parameter set, where the first processing parameter set includes geophysical information processing parameters. As used herein, a processing parameter set refers to a set of computer instruction parameters used for computer processing control. Geophysical information processing parameters include, but are not limited to, window parameters, low cutoff frequency, high cutoff frequency, center frequency, timing, filter type, and other parameters used by the computer to control information processing operations for processing geophysical information received by the computer.

Continuing with FIG. 4, a result is generated 404 and a second operation is performed 406 using the result from the first operation as an input to the second operation. The flow includes generating a result 408 from the second operation and evaluating the result 410. In one non-limiting example, the evaluation includes using a quality measurement of the second operation result.

The flow may end and the results used for other operations such as imaging when the evaluation shows that the operation results are acceptable 412. Otherwise the initial processing parameter set may be varied 412 and the operations are performed again and again evaluated. The method may include an iterative process to evaluate the effect of varying the processing parameter set to help ensure accurate results. In the example of FIG. 4, the first operation and the second operation are selected from geophysical processing operations that include, but are not limited to, noise attenuation operations, wavelet handling operations, imaging operations, velocity operations, and/or refraction statics. In another non-limiting example, the first operation and the second operation are selected sub-operations within one or more of attenuation operations, wavelet handling operations, imaging operations, velocity operations, and/or refraction statics.

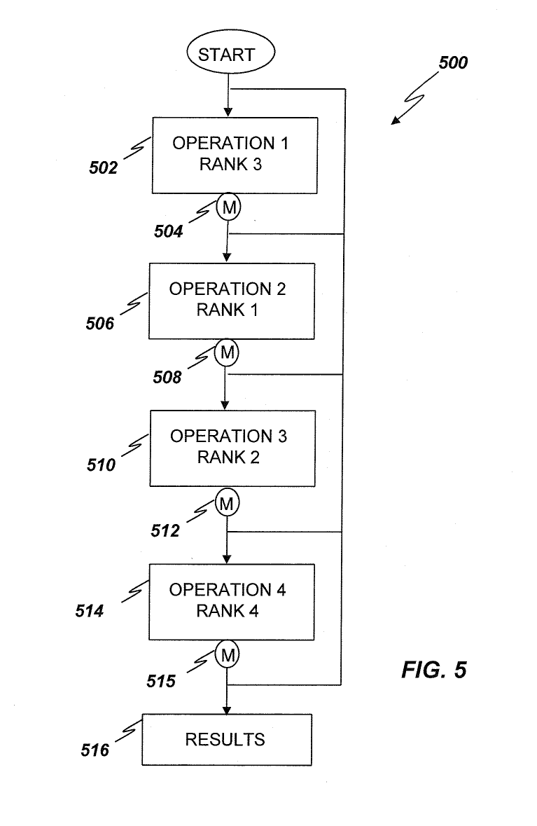

FIG. 5 is a non-limiting example of a method 500 using quality measurement points and ranking for several operations. In some seismic processing, the number of operations performed on a set of initial information may be quite large. It may therefore be useful to utilize a ranking scheme for the several operations. FIG. 5 illustrates that several operations may be ranked in a predetermined manner to effectively utilize quality control measurements for the process.

Geophysical information is entered into a computer performing the method 500, and a first operation 502 is carried out on the information. A quality measurement point 504 may be used at an output of the first operation. A second operation 506 is carried out on the output of the first operation, and a quality measurement point 508 may be used at an output of the second operation. Any number of operations and measurement points may be used, and the present example shows a third operation 510 with quality measurement point 512 and a fourth operation 514 having a quality measurement 515. The totality of the operations 1-4 may be used to produce results 516, which may be used for other computer operations such as generating an image of the earth subsurface structure.

Each operation 1-5 is ranked using ranking parameters. For example here operation 1 is ranked third, operation 2 is ranked first, operation 3 is ranked second, and operation 4 is ranked fourth. In this manner, the evaluation process described earlier may be carried out on the several operations in an efficient manner. The ranking parameters are selected to establish evaluation criteria in the event a problem is indicated at a measurement point. For example, a low-ranked operation may have a measurement indicating a problem, but the ranking allows the overall processing to continue due to a negligible effect of a problem in the low rank operation. However, a measurement indicating a problem with a high ranking operation may cause the computer to vary input parameters and recalculate results. Where a low ranking operation is easily corrected or re-run, then the computer may execute instructions for evaluating when a low ranking operation may be re-run.

In the example of FIG. 5, the several operations 1-4 may be any geophysical processing operation. In one non-limiting example, the first operation, the second operation, the third operation and the fourth operation may be selected from geophysical processing operations that include, but are not limited to, noise attenuation operations, wavelet handling operations, imaging operations, velocity operations, and/or refraction statics. In another non-limiting example, the first operation, the second operation, the third operation and the fourth operation may be selected sub-operations within one or more of attenuation operations, wavelet handling operations, imaging operations, velocity operations, and/or refraction statics.

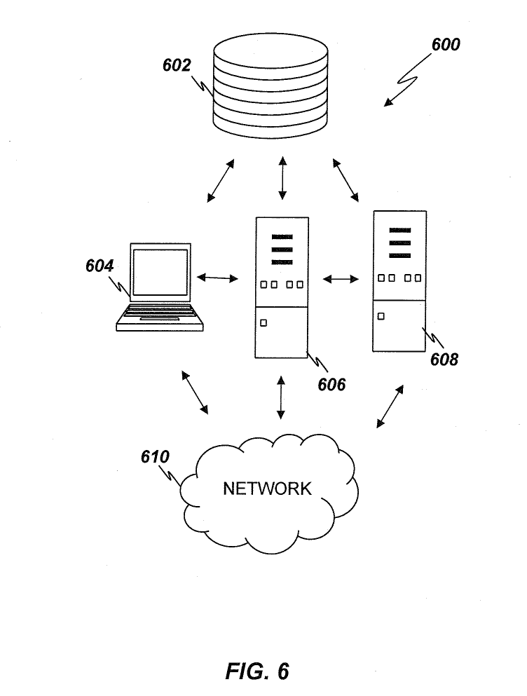

FIG. 6 illustrates a non-limiting an information processing system 600 that may be used to carry out the methods disclosed herein. Geophysical information may be gathered from a system 100 as described above and shown in FIG. 1. In several non-limiting examples, the system 600 may include one or more or any combination of the components shown in FIG. 6. In one example, the system 600 may include one or more processing devices such as a computer and a storage device 602. The computer may be selected from any number of useful computer devices, examples of which include, but are not limited to, laptop computers 604, desk top computers 606, mainframes 608 and the like. While a laptop-type is shown, the processing unit need not include user interface devices. However, when appropriate, the computer 604 may include a display, keyboard and or other input/output devices such as printers/plotters, a mouse, touch screen, audio output and input or any other suitable user interface.

The computer 604 may be in communication with the storage device 602 via any known interface and an interface for entering information into the computer 604, 606, 608 may be any acceptable interface. For example, the interface may include the use of a network interface 610.

The storage device 602 may be any useful storage device having a computer-readable media. Instructions for carrying out the disclosed method may be stored on computer-readable media in the computer 604, 606, 608 or may be stored on an external storage device 602.

Having described above the several aspects of the disclosure, one skilled in the art will appreciate several particular embodiments useful in determining a property of an earth subsurface structure.

In one particular embodiment, a method for determining a property related to an earth subsurface structure includes performing a first processing operation on geophysical information using a computer operating according to a first processing parameter set and generating a first result from the first processing operation. A second processing operation is performed on the first result using the computer and a second result is generated from the second operation. At least one measurement point of the second result is evaluated using the computer. The first processing parameter set is varied at least once to a second processing parameter set for processing the geophysical information. The first operation, the second operation and the evaluation are repeated using the second processing parameter set, wherein at least one of the first result, the second result and the evaluation is used for generating the property relating to the earth subsurface structure.

In one particular embodiment, a method for determining a property related to an earth subsurface structure includes using geophysical information that includes seismic information.

In one particular embodiment, a method for determining a property related to an earth subsurface structure includes using geophysical information that includes 3D seismic information.

In one particular embodiment, a method for determining a property related to an earth subsurface structure includes using geophysical information that includes 3-component sensor information obtained from a seismic survey using 3-component seismic sensors.

In another particular embodiment, a method for determining a property related to an earth subsurface structure includes using 3D seismic information that includes acceleration information obtained using accelerometers.

In another particular embodiment, a method for determining a property related to an earth subsurface structure includes using full-wave seismic information.

In one particular embodiment, a method for determining a property related to an earth subsurface structure includes using a model that suggests a second processing parameter set for use in the second operation.

In yet another particular embodiment, a method for determining a property related to an earth subsurface structure includes using a measurement point selected from one or more of a signal-to-noise ratio, a range of coherency, a smoothing radius, and a sampling within a statics calculation.

In one particular embodiment, a method for determining a property related to an earth subsurface structure includes using a first processing parameter set that includes selection of one or more seismic picks.

In one particular embodiment, a method for determining a property related to an earth subsurface structure includes using a processing parameter set that includes a set of filters for seismic information.

In one particular embodiment, a method for determining a property related to an earth subsurface structure includes a using one or more of a filtering operation, a deconvolution, an amplitude analysis, a velocity analysis, a move out operation, and a statics calculation for at least one of the first operation and the second operation.

In one particular embodiment, a method for determining a property related to an earth subsurface structure includes using ranking parameters for at least one of the first parameter set and the second parameter set.

In another particular embodiment, a method for determining a property related to an earth subsurface structure using the computer to evaluate the ranking parameters set when varying the first processing parameter set.

Those skilled in the art will also appreciate that a computer executing instructions stored on a computer-readable medium is also within the scope of the disclosure.

In one particular embodiment, a computer-readable medium having computer executable instructions stored thereon, that when executed using a computer, perform a method that includes performing a first processing operation on geophysical information using a computer operating according to a first processing parameter set, generating a first result from the first processing operation, performing a second processing operation on the first result using the computer, generating a second result from the second operation, evaluating at least one measurement point of the second result using the computer, varying the first processing parameter set at least once to a second processing parameter for processing the geophysical information, and repeating the first operation, the second operation and the evaluation using the second processing parameter set, wherein at least one of the first result, the second result and the evaluation is used for generating the property relating to the earth subsurface structure.

In another particular embodiment, a computer-readable medium having computer executable instructions stored thereon, that when executed using a computer, perform a method that includes using geophysical information that includes seismic information.

In another particular embodiment, a computer-readable medium having computer executable instructions stored thereon, that when executed using a computer, perform a method that includes using geophysical information that includes 3D seismic information.

In one particular embodiment the geophysical information includes 3-component sensor information obtained from a seismic survey using 3-component seismic sensors. In another particular embodiment the 3D seismic information includes acceleration information obtained using accelerometers. In another particular embodiment the instructions include using full-wave seismic information.

The instructions may further include using a model that suggests the second parameter set for use in the second operation.

The measurement point in several embodiments may be selected from one or more of a signal-to-noise ratio, a range of coherency, a smoothing radius, and a sampling within a statics calculation.

In another particular embodiment the first processing parameter set includes the selection of one or more seismic picks. In one embodiment the first processing parameter set includes a set of filters for seismic information.

The instructions for performing at least one of the first operation and the second operation in another particular embodiment include one or more of a filtering operation, a deconvolution, an amplitude analysis, a velocity analysis, a move out operation, and a statics calculation.

In yet another embodiment, the instructions further include instructions for using ranking parameters for at least one of the first processing parameter set and the second processing parameter set. The instructions in another embodiment include instructions for using the computer to evaluate the ranking parameters when varying the first parameter set.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A method for determining a property related to an earth subsurface structure, the method comprising:
performing a first processing operation on geophysical information using a computer operating according to a first processing parameter set;
generating a first result from the first processing operation;
performing a second processing operation on the first result using the computer;
generating a second result from the second operation;
evaluating at least one measurement point of the second result using the computer;
varying the first processing parameter set at least once to a second processing parameter set for processing the geophysical information; and
repeating the first operation, the second operation and the evaluation using the second processing parameter set, wherein at least one of the first result, the second result and the evaluation is used for generating the property relating to the earth subsurface structure.

2. The method of claim 1, wherein the geophysical information includes seismic information.

3. The method of claim 1, wherein the geophysical information includes 3D seismic information.

4. The method of claim 1, wherein the geophysical information includes 3-component sensor information obtained from a seismic survey using 3-component seismic sensors.

5. The method of claim 3, wherein the 3D seismic information includes acceleration information obtained using accelerometers.

6. The method of claim 1, wherein at least one of the first processing parameter set and the second processing parameter set includes parameters for processing full-wave seismic information.

7. The method of claim 1 further comprising using a model that suggests the second parameter set for use in the second operation.

8. The method of claim 1, wherein measurement point is selected from one or more of a signal-to-noise ratio, a range of coherency, a smoothing radius, and a sampling within a statics calculation.

9. The method of claim 1, wherein the first processing parameter set includes selection of one or more seismic picks.

10. The method of claim 1, wherein the first processing parameter set includes a set of filters for seismic information.

11. The method of claim 1, wherein at least one of the first operation and the second operation includes one or more of a filtering operation, a deconvolution, an amplitude analysis, a velocity analysis, a move out operation, and a statics calculation.

12. The method of claim 1 further comprising using ranking parameters for at least one of the first processing parameter set and the second processing parameter set.

13. The method of claim 12 further comprising using the computer to evaluate the ranking parameters when varying the first processing parameter set.

14. A computer-readable medium having computer executable instructions stored thereon, that when executed using a computer, perform a method comprising:
performing a first processing operation on geophysical information using a computer operating according to a first processing parameter set;
generating a first result from the first processing operation;
performing a second processing operation on the first result using the computer;
generating a second result from the second operation;
evaluating at least one measurement point of the second result using the computer;
varying the first processing parameter set at least once to a second processing parameter set for processing the geophysical information; and
repeating the first operation, the second operation and the evaluation using the second processing parameter set, wherein at least one of the first result, the second result and the evaluation is used for generating the property relating to the earth subsurface structure.

15. The computer-readable medium of claim 14, wherein the geophysical information includes seismic information.

16. The method of claim 14, wherein the geophysical information includes 3D seismic information.

17. The computer-readable medium of claim 14, wherein the geophysical information includes 3-component sensor information obtained from a seismic survey using 3-component seismic sensors.

18. The computer-readable medium of claim 16, wherein the 3D seismic information includes acceleration information obtained using accelerometers.

19. The computer-readable medium of claim 14, wherein the instructions for using at least one of the first processing parameter set and the second processing parameter set include using parameters for processing full-wave seismic information.

20. The computer-readable medium of claim 14, wherein the instructions further include using a model that suggests the second processing parameter set for use in the second operation.

21. The computer-readable medium of claim 14, wherein measurement point is selected from one or more of a signal-to-noise ratio, a range of coherency, a smoothing radius, and a sampling within a statics calculation.

22. The computer-readable medium of claim 14, wherein the first processing parameter set includes selection of one or more seismic picks.

23. The computer-readable medium of claim 14, wherein the first processing parameter set includes a set of filters for seismic information.

24. The computer-readable medium of claim 14, wherein the instructions for performing at least one of the first operation and the second operation include one or more of a filtering operation, a deconvolution, an amplitude analysis, a velocity analysis, a move out operation, and a statics calculation.

25. The computer-readable medium of claim 14, wherein the instructions further include instructions for using ranking parameters for at least one of the first processing parameter set and the second processing parameter set.

26. The computer-readable medium of claim 25, wherein the instructions further include instructions for using the computer to evaluate the ranking parameters when varying the first processing parameter set.
